(19) United States
(12) Patent Application Publication
(10) Pub. No.: US 2008/0071604 A1
(43) Pub. Date: Mar. 20, 2008

(54) METHOD AND APPARATUS FOR SELLING SOLAR ROOFS

(76) Inventor: Joseph T. Scanlan, Palatine, IL (US)

Correspondence Address: Welsh & Katz, Ltd.;Jon P. Christensen, 22nd Floor, 120 South Riverside Plaza, Chicago, IL, 60606, US

(21) Appl. No.: 11/693,123

(22) Filed: Mar. 29, 2007

Related U.S. Application Data
(60) Provisional application No. 60/798,176, filed on May 5, 2006.

(51) Int. Cl. G06Q 99/00; G06F 17/00

(52) U.S. Cl. 705/10

(57) ABSTRACT

A method and apparatus are provided for selling solar roofs. The method includes the steps of estimating an internal cost of a roof and of a solar system disposed over the roof and apportioning at least some of the costs between the roof and solar system. The method further includes the steps of adding a profit to the apportioned cost of the solar system to provide a solar project estimate, adding the solar project estimate to the apportioned roof cost to provide a project estimate and calculating a return cash flow over a predetermined time period from the project estimate of the roof and solar system. The method also includes the step of determining a dollar value that a competitor would be required to charge for a competitive roof alone to achieve a comparable return cash flow over the predetermined time period.

### FIELD OF THE INVENTION

The field of the invention relates to solar roofs and more particularly to methods of selling solar roofs.

### BACKGROUND OF THE INVENTION

This application claims the benefit of U.S. Prov. Pat. Appl. No. 60/798,176, filed on May 5, 2006.

The use of solar energy is generally known. While some buildings or other structures are initially constructed with the use of solar energy in mind, solar collectors can also be added at a later date in the form of solar panels.

Solar panels can be provided to simply collect heat for the purpose of heating water or to generate electricity. While either type of solar panel have their own specific applications, solar electric panels are easier to use on roofs because it is typically easier to route electrical energy to locations of use.

The placement of solar electric panels on roofs is a particularly good location since a roof is generally above any shading trees and because the remoteness of a roof reduces the possibility of incidental damage or vandalism.

Solar power is generally considered to be an important resource because it reduces a nation's dependence on foreign oil. However, solar panels are expensive and are subject to reduced power output on cloudy days and during the shorter daylight hours of winter.

In order to increase the use of solar energy, the U.S. Government offers up to a 30% rebate on solar systems. Many state governments also offer rebates.

In spite of the presence of rebates, the expense of solar panels has caused very few solar panels to be used in residential applications. In general, most homeowners are reluctant to install solar panels because of the long time period required to recover the investment. On the other hand, many businesses would benefit if they were able to justify the cost of solar energy. Accordingly, a need exists for a way of providing better incentives to the use of solar energy.

### SUMMARY

A method and apparatus are provided for selling solar roofs. The method includes the steps of estimating an internal cost of a roof and of a solar system disposed over the roof and apportioning at least some of the costs between the roof and solar system. The method further includes the steps of adding a profit to the apportioned cost of the solar system to provide a solar project estimate, adding the solar project estimate to the apportioned roof cost to provide a project estimate and calculating a return cash flow over a predetermined time period from the project estimate of the roof and solar system. The method also includes the step of determining a dollar value that a competitor would be required to charge for a competitive roof alone to achieve a comparable return cash flow over the predetermined time period.

### BRIEF DESCRIPTION OF THE DRAWINGS

FIG. 1 is a block diagram of a system for selling solar roofs in accordance with an illustrated embodiment of the invention;

FIG. 2 is a cash flow diagram that may be generated by the system of FIG. 1;

FIG. 3 provides additional detail of the diagram of FIG. 2; and

FIG. 4 provides additional detail of the cash flow diagram of FIG. 2.

### DETAILED DESCRIPTION OF AN ILLUSTRATED EMBODIMENT

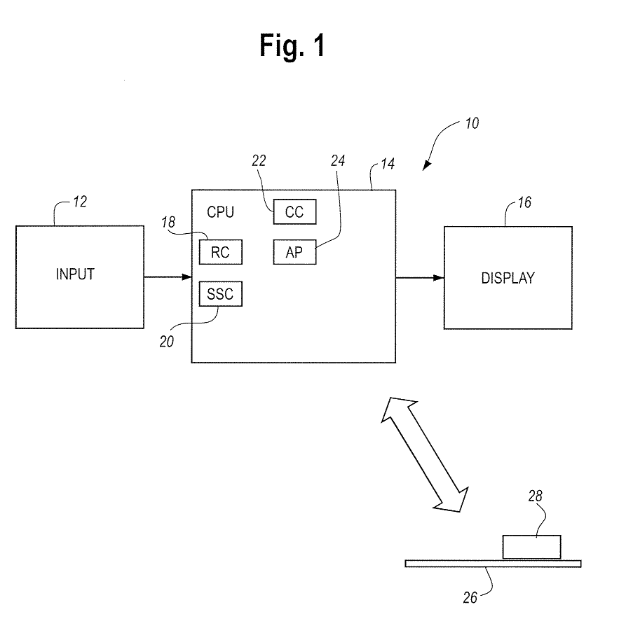

FIG. 1 depicts a estimating system 10 shown generally in accordance with an illustrated embodiment of the invention. Included within the system 10 may be a central processing unit (CPU) 14, an input system 12, such as a keyboard, and a display 16, such as a plasma screen display or CRT.

The system 10 may be used by a sales organization to gain a competitive advantage in the sale of an installed product. For example, a salesperson may be asked to provide a quotation for providing and installing the product. In response, the salesperson may call a supplier to find out his/her cost for the product and than calculate (guess at) his/her cost of installing the product. (The salesperson's cost for something will hereafter be referred to as the salesperson's internal cost.) The salesperson may add a profit (e.g., a predetermined percent, a fixed dollar value, etc.) to his/her internal costs for the product and installation and sum the result or sum the internal costs and then add the profit to provide a final customer estimate.

If the customer goes to another salesperson, the process may be repeated. If the salesperson, uses the same supplier, then the product cost may be the same for both salespeople. Ultimately, the successful salesperson may be the salesperson who is the better estimator of labor costs or who makes a mistake.

In order to improve their odds, at least some salesmen will attempt to upsell to the customer. In this case, the salesperson may attempt to convince the customer to choose a different product or that his product or installation is of a better quality in an attempt to justify a higher cost to the customer.

When this happens at least some customers will simply ask the other salesperson to provide an updated quotation based upon the added or changed products or services. In this situation, the work may, again, go to the better estimator or the salesperson who makes a mistake.

On the other hand, there are other ways to reduce the overall cost perceived by a customer on a customer project that does not impact the salesperson's profit and that is neither illegal or unethical. One avenue may be to include government incentives as a portion of the quotation in order to help the customer justify the cost of the project. Another avenue may be to include depreciation. Still another avenue may include upselling additional products and apportioning profits and costs based upon governmental incentives.

In the U.S., IRS tax rules require that at least some product and installation costs be totaled for purposes of incentives and depreciation. However, IRS rules also require that the product and installation costs of integrated products be kept separate even though they are part of the same customer estimate and would be part of a single installation.

Roofs and solar systems installed on roofs are examples of such a situation. In general, the estimating system 10 operates by receiving information about and providing estimates for weather roofs 26 (FIG. 1) with solar systems 28. As used herein, a weather roof is any type of roof that keeps out the weather. A solar roof includes a weather roof with a solar system disposed on top of the weather roof.

IRS rules require that commercial roofs (product and installation) be depreciated over a 39.5 year period even though a roof may only last 20 years and a supplier may only warranty the roof for 15 years. On the other hand, the IRS offers a 30% rebate on solar systems and a 5 year (MACRS) depreciation time period.

From the point of view of a roofing contractor, the sale of a roof with a solar system offers competitive advantages. For example, the contractor may offer a customer estimate for a roof and solar system that includes very little or no profit on the roof and a relatively large profit on the solar system. Alternatively, the contractor may take a loss on the roof with the loss made up by adding an additional profit to the solar system. This reduces the overall cost to the customer because of the 30% rebate on the solar system. In effect, the 30% rebate has a greater impact on the overall cost to the customer when the majority of the contractor's profit and costs are apportioned to the solar system.

Moreover, the incorporation of a solar system into a roof system offers an additional advantage because the solar roof contactor can calculate the minimum cost of a competitor's quote (where the competitor provides a roof alone, i.e., without a solar system) that substantially matches the cash flow generated by the solar roof system (due to rebates, depreciation factors, etc.). Knowledge of the probable value of a competitor's quote offers the solar roof contractor a significant competitive advantage by allowing the solar roof contractor to adjust his own overall profit accordingly. Moreover, the competitive advantage provided to a roof contractor advances the national energy policy by fostering a direct comparison between the return cash flow generated by a cheaper roof (by itself) and the return cash flow generated by a solar roof system in a way that would not be available to the customer in isolation.

Turning now to the estimating system 10, an example will be offered of a particular situation where a customer requests a quotation from a salesperson for a new roof. The salesperson may begin by calculating his internal cost for the roof in a conventional manner or the salesperson may allow the system 10 to calculate his internal costs. In the situation where the salesperson allows the estimating system to provide the quotation, the salesperson may first enter the dimensions of the roof and any special situations that may increase a cost of installation.

Upon activation, the system 10 may download one or more interactive screens that allow the salesperson to enter information regarding the roof. For example, a first screen may provide one or more interactive windows where the salesperson is asked to enter the dimensions of the roof and any cost factors. Cost factors may include the type of roof involved (e.g., built up, membrane, asphalt shingle, etc.) and the roof environment (e.g., slope is greater than 40°, no nearby parking, etc.).

Upon entering the appropriate information, the entered information is transferred to a roof calculator 16 where an initial determination is made for the internal cost of the roof. The roof calculator 16 may first determine an overall size of roof, in square feet. Next the roof calculator 16 may determine an internal product cost by multiplying the size of the roof by the cost per square foot of roofing materials. Finally, the roof calculator 16 may calculate a cost for installation by multiplying the size of the roof by the average labor cost to install the roof using the appropriate cost factors.

The estimation system 10 may also provide an estimate for a solar system to be installed along with the weather roof. The size of the solar system may be based upon some proportioning factor. For example, a solar system calculator 20 within the estimation system 10 may retrieve the overall roof size from the roof calculator 18 and multiply it by some factor (e.g., 30%) to obtain a proposed size of the solar system.

Once the solar calculator has a proposed size, the solar calculator 20 may retrieve a set of solar information files containing estimating information about solar systems. One file may include the size of appropriate solar panels and power inverters to convert an output from the solar panels into electric power to be consumed by the customer or placed back onto the power grid.

From the solar information files, the solar calculator 20 may determine the number and type of solar electric panels that are optimized for the roof size contemplated. An inverter may be selected on the same basis. With the number of solar panels and inverter identified, the solar calculator 20 may determine an internal cost for the solar system.

Once the internal cost of the roof and solar system are calculated, the roof calculator 18 and the solar calculator 20 may transfer the internal costs to an apportionment processor 24 of the system 10. The apportionment processor 24 may display the internal costs to the salesperson on an internal costs screen. Also shown on the internal costs screen may be a set of apportionment softkeys used to reapportion costs. In one embodiment, at least some or none of the internal cost for the roof may be apportioned to the solar system or visa versa. The apportionment softkeys may be labeled with “+” or “−” legends. Each activation of the “+” softkey may cause $1,000 to be transferred by the apportionment processor 24 from the internal roof cost to the internal solar system cost and similarly, each activation of the “−” softkey causes $1,000 to be transferred from the internal solar system cost to the internal roof costs.

In one embodiment, profit may be added to the internal (or apportioned) cost of the solar system alone with very little or no profit added to the internal (or apportioned) roof estimate. In another embodiment, profits may be added to both the apportioned internal solar system cost and the apportioned internal roof cost to provide the final customer estimates. Profit may be added via an adder within the apportionment processor 24 by activation of a profit softkey followed by entry of a percent value for one or both of the solar and roof costs or by activation of the “+” or “−” softkeys to add profit incrementally.

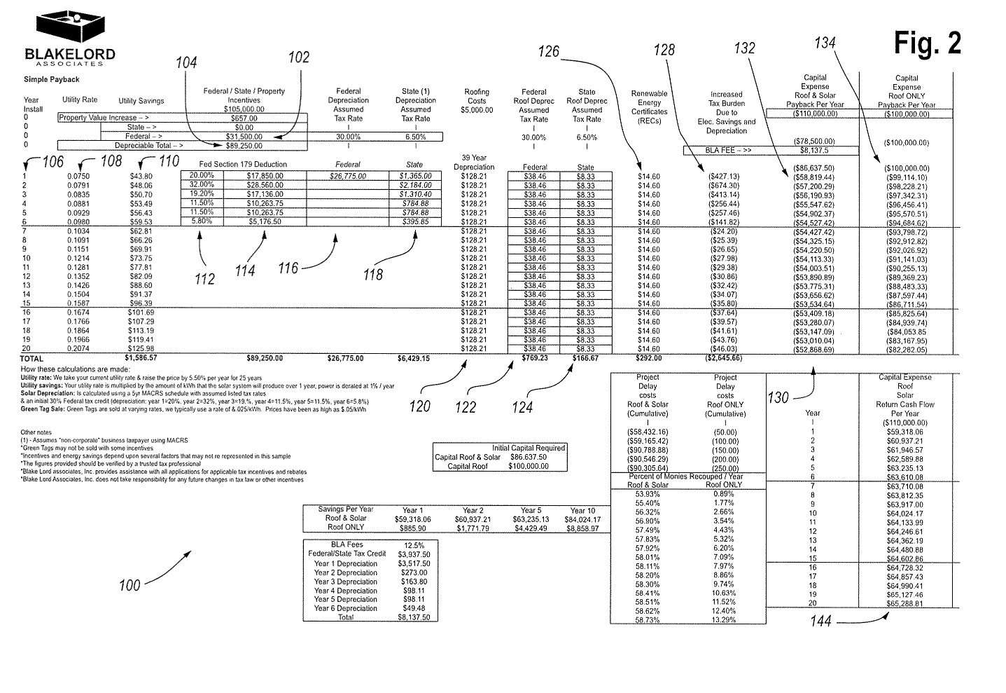

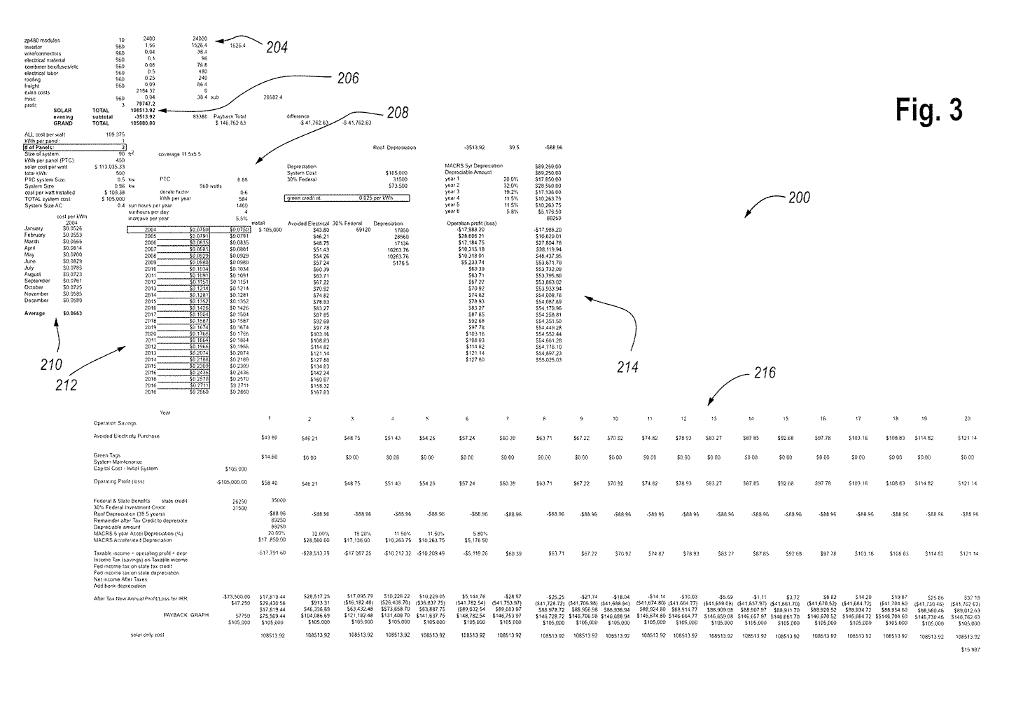

Once the estimated costs to the customer are determined, the apportionment processor 24 may transfer the customer estimates to a cash flow processor 22 of the system 10 which generates a set of cash flow estimates or diagrams 100, 200. The cash flow estimates 100, 200 may be provided in the form shown in FIGS. 2 and 3.

For the example of FIG. 2, the customer estimate for the roof is $100,000 and the customer estimate for the solar system is $10,000. These costs would include the salesperson's internal costs, plus a profit.

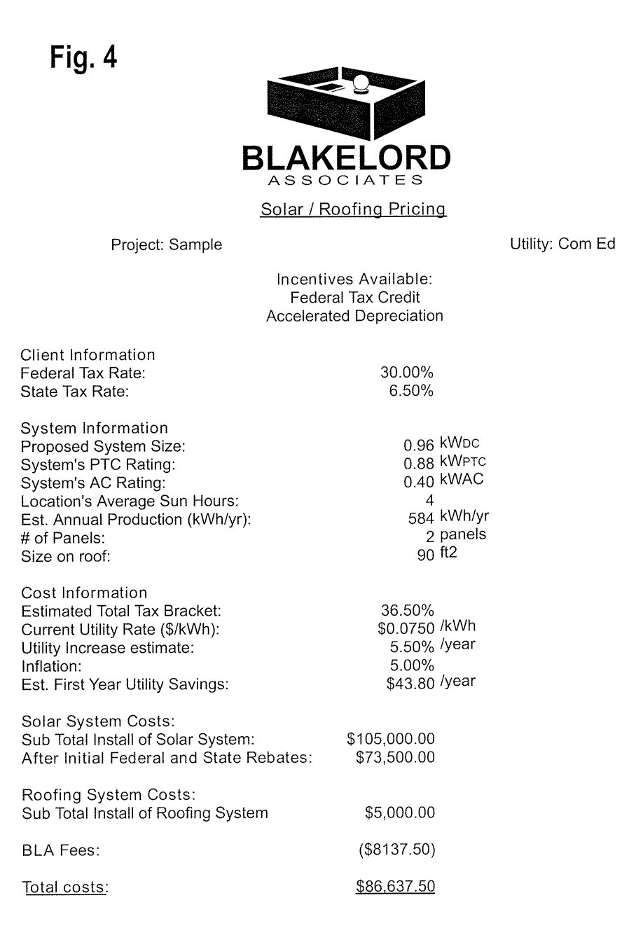

In the extreme example depicted in FIGS. 24, $95,000 of the customer estimate for the roof is reapportioned from the roof to the solar system resulting in a customer estimate for the roof of $5,000 and a customer estimate for the solar system of $105,000. FIG. 4 shows details of the solar system under this example.

As shown in FIG. 2, the solar system customer estimate of $105,000 is entitled to a 30% federal incentive 102. In this case, the federal incentive has a value of $31,500.

However, only 50% of the federal incentive can be used to determine a depreciable total 104. After deduction of one-half of the federal incentive, the depreciable total is $89,250.

Shown along the left side of the cash flow estimate 100 is a first column 106 showing the years following installation of the solar and roof system. A second column 108 shows a utility rate. As may be noted, the electric utility rate for the first year is $0.075/kWh. For every year after that, the utility rate increases by an estimated 4%.

The third column 110 on the estimate 100 shows the utility savings provided by the solar system using the energy output shown in FIG. 4. As shown, the utility savings increases each year based upon the utility rate increase.

The fourth column 112 shows the Federal Section 107 deductions over the 6 year depreciation period. As shown, 20% of the depreciable total 104 is allowed the first year, 32% the second year, 19.2% the third year, 11.5% the fourth year, 11.5% the fifth year and 5.8% the sixth year.

The fifth column 114 shows the dollar value of the Federal Section 107 deductions over the six year period. As shown, the first year deduction is $17,850, the second year is $28,560, the third year is $17,136, the fourth year is $10,263, the fifth $10,263 and the sixth year is is $5,176.

The sixth column 116 shows the federal tax avoided by the customer. In this case, where the customer has a 30% tax rate, the expenditure of the depreciable total 104 would result in a tax avoidance of $26,775.

The seventh column 118 shows the avoided state tax, assuming a 6.5% tax rate. As shown, the avoided tax the first year is $1,365, the second year is $2,184, the third year is $1,310, the fourth year is $784, the fifth year is $785 and the sixth year is $395.

The eighth column 120 shows depreciation of the roof over the 39 year time period required by the U.S. IRS. As shown the depreciation is $128 per year.

The ninth column 122 shows the avoided federal taxes at a 30% tax rate due to roof depreciation to have a value of $38/year. The tenth column 124 shows avoided state taxes at a 6.5% rate due to roof depreciation to have a value of $8/year.

The eleventh column 126 shows the renewable energy certificates generated by the customer for installing a solar roof. The renewable energy certificates may be retained by the customer for his/her own use or sold for the value shown.

The twelfth column 128 shows the increased tax burden due to electricity savings and depreciation.

The thirteenth column 130 shows the capital expense (roof and solar) payback per year. (It should be noted that to extend the payback for as long as possible (i.e., to be as conservative as possible), a 12.5% fee 132 has been added by the salesperson.) Similarly, the fourteenth column 134 shows the capital expense (roof only) payback per year.

The fifteenth column 136 shows a comparison of payback per year between the roof and solar system versus the roof only. The fifteenth column 136 highlights the significant payback generated by the depreciation and federal incentives.

As a further example, the sixteenth column 138 shows the capital expense payback for roof and solar system without energy savings. It can be seen from this column 138 that solar energy savings is dwarfed by the effects produced by incentives and depreciation.

Another set of columns 144, 146 show the return cash flow for the solar and roof system versus the roof alone over a twenty year period. As shown the return cash flow shown in the column 144 for the solar system and roof is significantly larger than the payback shown in column 146 for the roof alone.

The seventeenth column 140 shows a lifecyle savings (capital expense payback per year) that a competitor would have to charge for a roof alone to match the lifecycle savings of the roof and solar system. Column seventeen 140 demonstrates that the competitor would be required to provide a customer estimate of at least $62,000 to match the total customer estimate of $110,000 for the roof and solar system.

The values of the seventeenth column 140 are generated in the same way as the values from column 132. The initial value of $62,000 for this example may be achieved by substantially matching the value in the fifteenth year of column 140 with the value in the fifteenth year of column 132. This may be achieved by the appropriate depreciation program or by simply choosing an appropriate initial value 142 and comparing the results in the fifteenth year. If the value for the fifteenth year of column 140 is too low, then the value 142 may be iteratively increased until the values of columns 132 and 140 substantially match.

FIG. 3 shows another cash flow estimate 200 that shows additional details of the solar system. For example a first summary area 204 shows additional details from FIG. 4. For this extreme example, the detail area 204 shows a profit for the solar system of $79,747. Detail area 208 shows a total estimated output of the solar system to be 584 kWh per year. Detail area 210 shows changes in electricity costs for a particular year due to normal variations in electricity costs. Detail area 212 shows energy cost inflation at the 4% rate. Detail area 214 shows the operation profit (loss) per year. Detail area 216 shows the yearly cash flow among the cash flow centers.

In general, the ability for a salesperson to calculate a minimum value 142 that a competitor would have to charge for a product gives a salesperson a tremendous advantage over his/her competitors. The example of FIGS. 2-4 show a customer estimate for a roof and solar system for $110,000. Based upon the cash flow, the salesperson knows that the competitor would need to provide an estimate of at least $62,000 for a roof alone.

However, based upon the salesperson's knowledge of his/her own internal costs, the salesperson would also know the competitor's approximate internal costs. Accordingly, the salesperson can simply adjust his/her profits to equal the internal cost of the competitor plus a reasonable profit.

On the other hand, the salesperson could reduce the cost of the solar and roof system to equal the competitor's minimum estimate of $62,000 by reducing the salesperson's profit. However, the salesperson would also know that the solar system has additional value to the customer above the competitor's customer estimate and would incorporate that knowledge into the salesperson's final customer estimate.

In the example of FIGS. 2-4, the salesperson may determine a final customer estimate (e.g., $110,000) using a multistep process. First, the salesperson may determine the competitor's internal cost for his roof. The salesperson may then add a profit to the competitor's internal cost (e.g., the average in the industry for this type of roof) to provide the most likely competitor's estimate to the customer. The salesperson may then subtract the competitor's estimate from the $62,000 to determine the additional profit that the salesman may add to his internal roof cost to provide a preliminary estimate. The salesperson may then add the reasonable value of the solar system (internal cost plus profit) to the preliminary estimate to provide an initial customer estimate. If the total initial customer estimate from that process exceeds the $110,000 customer estimate (shown in the examples of FIGS. 2-4), then the salesperson could reduce his/her own profit by some amount, so that the salesperson's customer estimate has a better payback than the competitor's customer estimate. However, if the total customer estimate by that method is less than the $110,000 customer estimate, then the salesperson may choose to increase his/her profit even more and recalculate the paybacks of FIGS. 2-4.

A specific embodiment of method and apparatus for providing customer estimates has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of selling solar roofs comprising:
estimating an internal cost of a roof and of a solar system disposed on the roof;
apportioning internal costs between the roof and solar system;
adding a profit to the apportioned cost of the solar system to provide a solar project estimate;
adding the solar project estimate to the apportioned roof cost to provide a project estimate;
calculating a return cash flow over a predetermined time period from the project estimate; and
determining a dollar value that a competitor would charge for a comparable roof alone to achieve a substantially equal return cash flow over the predetermined time period.

2. The method as in claim 1 further comprises adding a profit to the apportioned cost of the roof.

3. The method as in claim 1 wherein calculating the return cash flow further comprises adding a Federal energy credit.

4. The method as in claim 1 wherein the Federal energy credit further comprises 30% of the solar project estimate.

5. The method as in claim 1 wherein calculating the return cash flow further comprises adding a state energy credit.

6. The method as in claim 1 wherein calculating the return cash flow further comprises adding an energy savings.

7. The method as in claim 1 wherein calculating the return cash flow further comprises subtracting an increased tax burden due to energy savings and depreciation.

8. The method as in claim 1 wherein calculating the return cash flow further comprises depreciating a depreciable portion of the solar project estimate over a six year period.

9. The method as in claim 1 wherein calculating the return cash flow further comprises depreciating the estimated internal roof cost over a 39 year period.

10. The method as in claim 1 wherein the predetermined time period further comprises 15 years or a predetermined roof warranty period.

11. The method as in claim 1 further comprising iteratively determining the dollar value that a competitor would charge.

12. An apparatus for selling solar roofs comprising:
a roof calculator that calculates an internal cost of a roof and of a solar system disposed on the roof;
an apportioning processor that apportions internal costs between the roof and solar system and adds a profit to the apportioned cost of the solar system to provide a solar project estimate and that adds the solar project estimate to the apportioned roof cost to provide a project estimate;
a cash flow processor that calculates a return cash flow over a predetermined time period from the project estimate; and
a dollar value that a competitor would be required to charge for a comparable roof alone to achieve a substantially equal return cash flow over the predetermined time period where the dollar value is determined from the calculated return cash flow.

13. The apparatus as in claim 13 further comprises a profit that is added to the apportioned cost of the roof.

14. The apparatus as in claim 13 wherein the calculated the return cash flow further comprises a Federal energy credit.

15. The apparatus as in claim 13 wherein the Federal energy credit further comprises 30% of the solar project estimate.

16. The apparatus as in claim 13 wherein the calculated return cash flow further comprises a state energy credit.

17. The apparatus as in claim 13 wherein the calculated return cash flow further comprises an energy savings.

18. The apparatus as in claim 13 wherein the calculated return cash flow further comprises an increased tax burden due to energy savings and depreciation subtracted from the calculated return cash flow.

19. The apparatus as in claim 13 wherein the calculated return cash flow further comprises a portion of the solar project estimate depreciated over a six year period.

20. The apparatus as in claim 13 wherein the calculated return cash flow further comprises the estimated internal roof cost depreciated over a 39 year period.

21. The apparatus as in claim 13 wherein the predetermined time period further comprises 15 years or a predetermined roof warranty period.

22. The apparatus as in claim 13 wherein the iteratively determined the dollar value that a competitor would charge further comprises an iterated value.

23. An apparatus for selling solar roofs comprising:
means for estimating an internal cost of a roof and of a solar system disposed on the roof;
means for apportioning internal costs between the roof and solar system;
means for adding a profit to the apportioned cost of the solar system to provide a solar project estimate;
means for adding the solar project estimate to the apportioned roof cost to provide a project estimate;
means for calculating a return cash flow over a predetermined time period from the project estimate of the roof and solar system; and
means for determining a dollar value that a competitor would charge for a comparable roof alone to achieve a substantially equal return cash flow over the predetermined time period.

24. A method of selling related products comprising:
estimating an internal cost of a first product and of a second product associated with the first product;
apportioning internal costs between the first and second products;
adding a profit to the apportioned cost of the second product to provide a first estimate;
adding the first estimate to the apportioned cost of the first product to provide a project estimate;
calculating a return cash flow provided by the first and second products over a predetermined time period from the project estimate; and
determining a dollar value that a competitor would charge for a comparable first product alone to achieve a substantially equal return cash flow over the predetermined time period.
